(19) United States
(12) Patent Application Publication
(10) Pub. No.: US 2003/0001894 A1
(43) Pub. Date: Jan. 2, 2003

(54) Method and apparatus for dynamically determining actions to perform for an object

(75) Inventors: James Russell Boykin, Pflugerville, TX (US); John Conrad Sanchez, Pflugerville, TX (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY (US)

(21) Appl. No.: 09/895,088

(22) Filed: Jun. 29, 2001

(51) Int. Cl. G06F 3/00

(52) U.S. Cl. 345/764; 345/810

(57) ABSTRACT

A method, apparatus, and computer implemented instructions for presenting actions associated with an object displayed in a graphical user interface in a data processing system. Actions are dynamically associated with the object. In response to a selection of the object, the actions are presented in the graphical user interface.

### BACKGROUND OF THE INVENTION

1. Technical Field

The present invention provides an improved data processing system and in particular a method and apparatus for manipulating data. Still more particularly, the present invention provides a method, apparatus, and computer implemented instructions for identifying actions that may be performed for an object.

2. Description of Related Art

The use of data processing systems has become widespread and pervasive in society. The interface through which a user interacts with a data processing system has advanced from the entry of command line commands to graphical user interfaces (GUIs). A graphical user interface (GUI) is a graphics-based user interface that incorporates icons, pull-down menus and a mouse. The GUI has become the standard way users interact with a computer. The GUI is used to perform actions such as, for example, start programs, terminate programs, communicate with other users at other data processing systems, and data manipulation. These actions are accomplished by the user employing input devices such as, for example, a mouse and a keyboard. Objects representing data and programs may be represented on the GUI using icons. Oftentimes, a list of actions that may be performed on an object are presented to the user in response to some input, such as a selection of a right mouse button, pressing a function key on a keyboard, or by moving a pointer over a certain region of the GUI.

The actions that may be performed on an object are numerous. For example, a user may copy, cut, delete, paste, run, export, or move an object. These actions may be presented to the user to allow the user to identify what actions may be taken and to provide an interface to execute a selected action. These actions are commonly presented in a pop-up menu for user selection. Currently, the actions that are presented to the user are predetermined and not easily changed. The actions that are associated with an object are hard coded. Hard coded software is software that is programmed to perform a fixed number of tasks without regard to future flexibility. This type of programming is very easy to perform and is the ideal kind of programming for one-time jobs. Such programs typically use a fixed set of values and may only work with certain types of devices. The problem with these types of programs is that one-time programs often become widely used, even in day-to-day operations, but they are difficult to change because the routines have not been generalized to accept change. Changing actions allowed on an object are difficult and require reinstalling or recompiling a program. The mechanism of the present invention also supports runtime determination of actions against object types when both the object type and related actions are not known at creation of the launching code.

Therefore, it would be advantageous to have an improved method, apparatus, and computer implemented instructions for determining actions that can be performed with an object.

### SUMMARY OF THE INVENTION

The present invention provides a method, apparatus, and computer implemented instructions for presenting actions associated with an object displayed in a graphical user interface in a data processing system. Actions are dynamically associated with the object. In response to a selection of the object, the actions are presented in the graphical user interface.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a data processing system in which the present invention may be implemented in accordance with a preferred embodiment of the present invention;

FIG. 2 is a block diagram of a data processing system in which the present invention may be implemented;

FIG. 3 is a diagram illustrating components used to dynamically determine actions that can be performed on an object in accordance with a preferred embodiment of the present invention;

FIG. 4 is a diagram of a graphical user interface in which actions are presented to a user in accordance with a preferred embodiment of the present invention;

FIG. 5 is a flowchart of a process used for registering actions in accordance with a preferred embodiment of the present invention;

FIG. 6 is a flowchart of a process used for adding menu items for a Java class in accordance with a preferred embodiment of the present invention;

FIG. 7 is a flowchart of a process used for populating a collection for a pop-up menu in accordance with a preferred embodiment of the present invention; and

FIG. 8 is a flowchart of a process used for executing an action in accordance with a preferred embodiment of the present invention.

### DETAILED DESCRIPTION OF THE PREFERRED EMBODIMENT

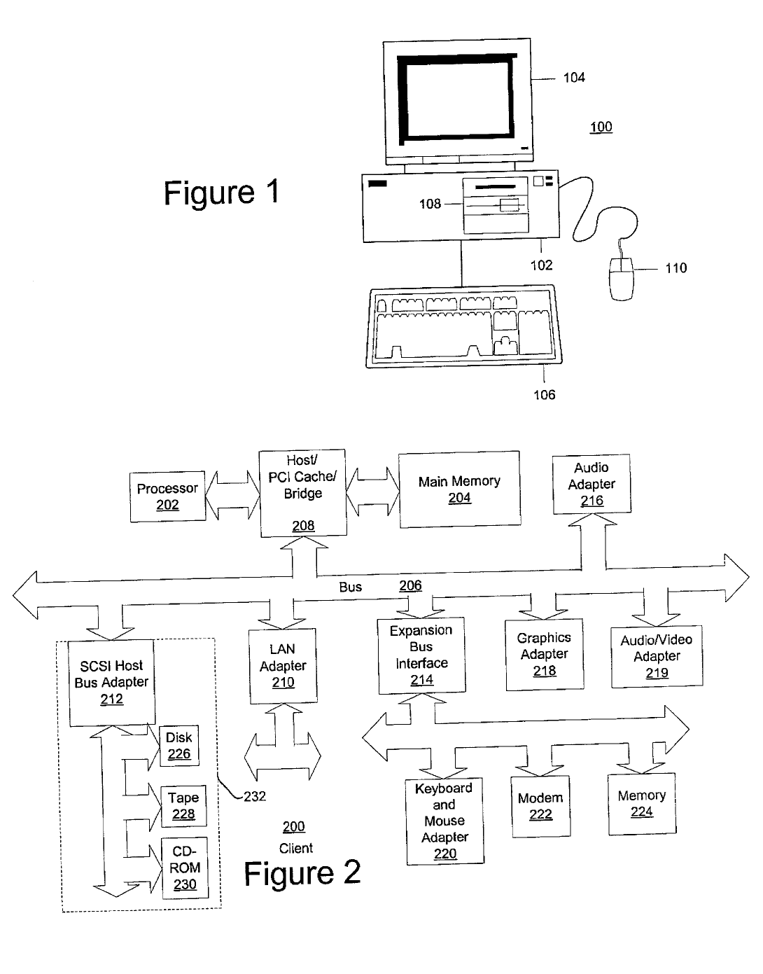

With reference now to the figures and in particular with reference to FIG. 1, a pictorial representation of a data processing system in which the present invention may be implemented is depicted in accordance with a preferred embodiment of the present invention. A computer 100 is depicted which includes system unit 102, video display terminal 104, keyboard 106, storage devices 108, which may include floppy drives and other types of permanent and removable storage media, and mouse 110. Additional input devices may be included with personal computer 100, such as, for example, a joystick, touchpad, touch screen, trackball, microphone, and the like. Computer 100 can be implemented using any suitable computer, such as an IBM eServer pSeries computer or IntelliStation computer, which are products of International Business Machines Corporation, located in Armonk, N.Y. Although the depicted representation shows a computer, other embodiments of the present invention may be implemented in other types of data processing systems, such as a network computer. Computer 100 also preferably includes a graphical user interface (GUI) that may be implemented by means of systems software residing in computer readable media in operation within computer 100.

With reference now to FIG. 2, a block diagram of a data processing system is shown in which the present invention may be implemented. Data processing system 200 is an example of a computer, such as computer 100 in FIG. 1, in which code or instructions implementing the processes of the present invention may be located. Data processing system 200 employs a peripheral component interconnect (PCI) local bus architecture. Although the depicted example employs a PCI bus, other bus architectures such as Accelerated Graphics Port (AGP) and Industry Standard Architecture (ISA) may be used. Processor 202 and main memory 204 are connected to PCI local bus 206 through PCI bridge 208. PCI bridge 208 also may include an integrated memory controller and cache memory for processor 202. Additional connections to PCI local bus 206 may be made through direct component interconnection or through add-in boards. In the depicted example, local area network (LAN) adapter 210, small computer system interface (SCSI) host bus adapter 212, and expansion bus interface 214 are connected to PCI local bus 206 by direct component connection. In contrast, audio adapter 216, graphics adapter 218, and audio/video adapter 219 are connected to PCI local bus 206 by add-in boards inserted into expansion slots. Expansion bus interface 214 provides a connection for a keyboard and mouse adapter 220, modem 222, and additional memory 224. SCSI host bus adapter 212 provides a connection for hard disk drive 226, tape drive 228, and CD-ROM drive 230. Typical PCI local bus implementations will support three or four PCI expansion slots or add-in connectors.

An operating system runs on processor 202 and is used to coordinate and provide control of various components within data processing system 200 in FIG. 2. The operating system may be a commercially available operating system such as Windows 2000, which is available from Microsoft Corporation. An object oriented programming system such as Java may run in conjunction with the operating system and provides calls to the operating system from Java programs or applications executing on data processing system 200. “Java” is a trademark of Sun Microsystems, Inc. Instructions for the operating system, the object-oriented programming system, and applications or programs are located on storage devices, such as hard disk drive 226, and may be loaded into main memory 204 for execution by processor 202.

Those of ordinary skill in the art will appreciate that the hardware in FIG. 2 may vary depending on the implementation. Other internal hardware or peripheral devices, such as flash ROM (or equivalent nonvolatile memory) or optical disk drives and the like, may be used in addition to or in place of the hardware depicted in FIG. 2. Also, the processes of the present invention may be applied to a multiprocessor data processing system.

For example, data processing system 200, if optionally configured as a network computer, may not include SCSI host bus adapter 212, hard disk drive 226, tape drive 228, and CD-ROM 230, as noted by dotted line 232 in FIG. 2 denoting optional inclusion. In that case, the computer, to be properly called a client computer, must include some type of network communication interface, such as LAN adapter 210, modem 222, or the like. As another example, data processing system 200 may be a stand-alone system configured to be bootable without relying on some type of network communication interface, whether or not data processing system 200 comprises some type of network communication interface. As a further example, data processing system 200 may be a personal digital assistant (PDA), which is configured with ROM and/or flash ROM to provide nonvolatile memory for storing operating system files and/or user-generated data.

The depicted example in FIG. 2 and above-described examples are not meant to imply architectural limitations. For example, data processing system 200 also may be a notebook computer or hand held computer in addition to taking the form of a PDA. Data processing system 200 also may be a kiosk or a Web appliance. The processes of the present invention are performed by processor 202 using computer implemented instructions, which may be located in a memory such as, for example, main memory 204, memory 224, or in one or more peripheral devices 226-230.

The present invention provides a method, apparatus, and computer implemented instructions for dynamically determining actions that are to be associated with an object. The mechanism of the present invention involves non hard-coded software, which is data independent with respect to the mappings of actions and their associations or mappings to objects. This type of software is written such that any data that can possibly be changed should be stored in a database and not “hard wired” into the code of the program. When values change or are added only the database item is altered, which is a simple task, rather than recompiling programs.

In these examples, the mechanism is implemented in the Java programming language. Mappings between actions to perform and an object's class type identify a set of allowable actions for a given object. This determination may be made at runtime. This mechanism allows existing relationships or associations of actions and objects to be determined at runtime based on the saved class type to actions' mappings. Examples of object types include security objects, such as roles, accounts, capabilities, principals, and persons. Other objects types may be, for example, Java Naming Directory Interface (JNDI) objects, such as javax.naming.Context (a folder) and javax.naming.directory.DirContext (a folder with attributes). These object types also may include an IP address, an IP node, and a gateway.

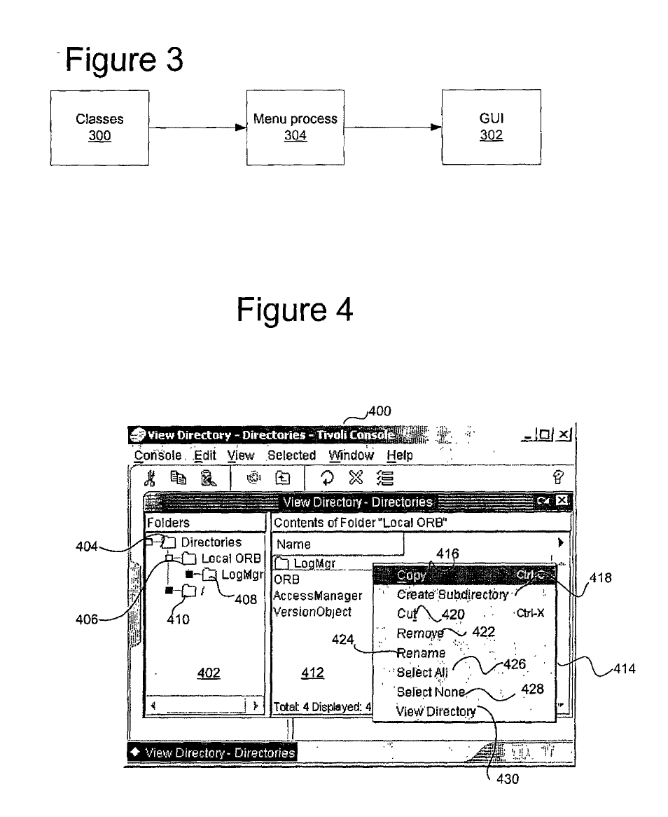

Turning next to FIG. 3, a diagram illustrating components used to dynamically determine actions that can be performed on an object is depicted in accordance with a preferred embodiment of the present invention. The components illustrated in FIG. 3 may be found in a data processing system, such as, for example, data processing system 200 in FIG. 2.

Classes 300 are classes for objects presented in GUI 302. Menu process 304 provides a mechanism to generate menus of actions that can be performed on objects. Menu process 304 receives classes 300 and dynamically determines which actions should be associated in preparation for displaying a pop-up menu. In these examples, menus are the form in which the actions are presented to a user. These examples are not meant to limit the fashion in which actions associated with objects can be presented. These associations are determined at runtime or at the time the program is executed in these examples. In this manner, actions may be added and removed from associations with objects such that the effects of these changes are presented to the user at runtime. An example of this mapping is a file system directory, which can have multiple actions related to it. Examples of these multiple actions are cut, copy, paste, rename, delete, create subdirectory, and view. A file system item such as a bat file has a different set of related actions even though some are common with the directory above. Some examples are cut, copy, rename, delete, and execute. In this example, the actions paste, create subdirectory and view are not applicable to a non-folder. But a new action of execute also has been added since a bat file is executable.

With reference now to FIG. 4, diagram of a graphical user interface in which actions are presented to a user is depicted in accordance with a preferred embodiment of the present invention. Window 400 is an example of a window that may be presented in a GUI, such as GUI 302 in FIG. 3.

In this example, window 400 is an interface for a file navigation program used to manipulate files and folders or directories in a file system. Window 400 shows a tree of folders in section 402. The folders are nodes in which the nodes are presented as folder icons, 404, 406, 408, and 410. Section 412 in window 400 illustrates the contents of folder 408. Pop-up window 414 shows actions that may be performed on folder 408. These actions include “Copy” 416, “Create Subdirectory” 418, “Cut” 420, “Remove” 422, “Rename” 424, “Select All” 426, “Select None” 428, and “View Directory” 430. In this example, these actions are identified dynamically at the time the program that presents the actions started. The time when this program starts is also referred to as “runtime”. In other words, actions associated with folder 408 may be changed and the change will be reflected the next time the program is started. Depending on the implementation, some actions may be hard-coded while others are dynamically determined. The two are combined to make the final pop-up menu. Examples of hard-coded actions in the file system are rename and remove. Examples of dynamically-determined actions are create subdirectory, view, and execute.

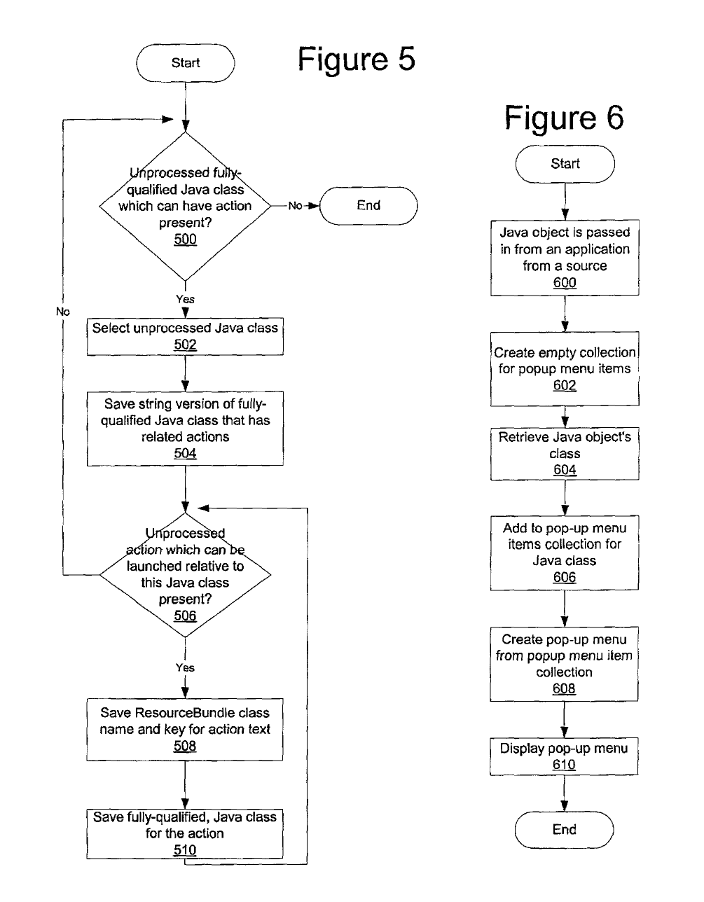

FIGS. 5-8 below illustrate processes used to dynamically identify actions associated with objects and generate a presentation of these actions. The flowcharts in FIGS. 5-8 are presented for an implementation of the present invention in the Java programming language. With reference now to FIG. 5, a flowchart of a process used for registering actions is depicted in accordance with a preferred embodiment of the present invention. The process illustrated in FIG. 5 occurs prior to runtime of a program in a registration phase. The source of the registered material may be, for example, XML, a GUI, or a command line. In these examples, the process in FIG. 5 stores data registering a Java class and its associated actions in a data structure, such as a database or a flat file on a file system.

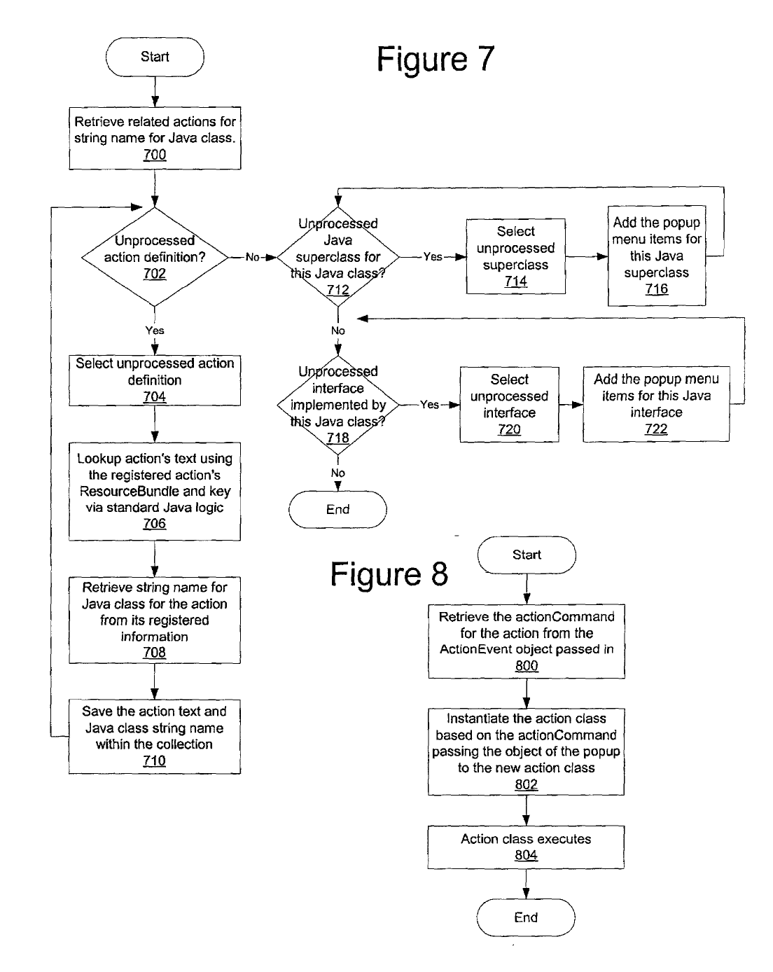

The process begins with a determination as to whether an unprocessed fully-qualified Java class, which can have an action, is present (step 500). A fully qualified Java class name includes the Java package in which it resides as a prefix. Most Java classes reside in packages to ensure that there is no name collision between two classes produced by two different companies, divisions, etc. For instance, the Java language has a standard class named “String”. The fully-qualified class name is java.lang.String. When storing the String class name, the fully-qualified java.lang.String is stored because there also could be a com.foo.String class. This action avoids confusing the two when determining related actions at runtime. The qualifiers are not mandatory, but product-level code typically uses package qualifiers to ensure that no collision of the class names occurs across companies, products, etc. So, the package qualification of a Java class is an intrinsic part of its name. An action is a separately-related object in its own right. If an unprocessed Java class is present in which the Java class can have an action, the unprocessed Java class is selected (step 502). The string version of the fully-qualified Java class that has related actions is saved (step 504). In the case of the Java String class, “java.lang.String” is saved in the data structure. This string version of the class is later used in step 700 in FIG. 7 as a lookup mechanism for related actions.

Next, a determination is made as to whether an unprocessed action, which can be launched relative to the Java class, is present (step 506). If an unprocessed action is absent, the process returns to step 500 as described above to determine whether additional unprocessed Java class are present. Otherwise, the ResourceBundle class name and key is saved for the action text (step 508). A ResourceBundle is Java's way of providing internationalized, separately-provided text for a Java program. The ResourceBundle includes a key for a string and then its value. In the case of an action, an actual example is a key of “CREATE_SUBDIR” with an English value of “Create Subdirectory”, a Spanish value of “Crear subdirectorio” and an Italian value of “Crea sottodirectory”. Depending on the language used at execution of the program, the user would see the appropriate text for their language for the create subdirectory action. The fully-qualified Java class is saved for the action (step 510) with the process returning to step 506. The fully-qualified class name of the Java class is saved in the data structure. That name is later used at runtime as a key for related actions to that Java class. In order to get the fully-qualified string class name for any Java object, you can do the following:

AnyJavaObject.getClass( ).getName( )

For instance, if you ask a Java Object of type String for its class(via someStringJavaObject.getClass( ).getName( )), “java.lang.String” will be returned.

With reference now to FIG. 6, a flowchart of a process used for adding menu items for a Java class is depicted in accordance with a preferred embodiment of the present invention. The process illustrated in FIG. 6 may be implemented in a menu process, such as menu process 304 in FIG. 3.

The process begins by passing a Java object in from an application from a source (step 600). This source may be, for example, an explorer, a tree, or a table. Next, an empty collection for pop-up menu items is created (step 602). This collection also is referred to as a pop-up menu items collection. Then, the Java object's class is retrieved (step 604). Actions are added to the pop-up menu items collection for the Java class (step 606). Step 606 is described in more detail in FIG. 7 below. A pop-up menu is created from the pop-up menu item collection (step 608). This step includes registering ActionListeners for each pop-up menu item and recording the actionCommand as the Java class needed to perform the related action. The pop-up menu is displayed (step 610) and the process terminates.

Turning next to FIG. 7, a flowchart of a process used for populating a collection for a pop-up menu is depicted in accordance with a preferred embodiment of the present invention. The process illustrated in FIG. 7 may be implemented in a menu process, such as menu process 304 in FIG. 3. This process is used to store action information in a collection and may call itself in a recursive fashion.

The process begins by retrieving related actions for the string name for the Java class (step 700). In these examples, the related actions are retrieved from a database or a flat file. The actions are stored using information generated by registration of classes as illustrated in FIG. 5 above. These actions are in the form of action definitions in this example. Next, a determination is made as to whether an unprocessed action definition is present (step 702). If unprocessed action definitions are present, an unprocessed action definition is selected for processing (step 704). The text for the action is looked up using a ResourceBundle and a key for the registered action using standard Java logic (step 706). A string name for the Java class for the action is retrieved from the registered information (step 708). Then, the action text and the Java class string name are saved in the collection (step 710) with the process then returning to step 702 as described above. The collection is the pop-up menu items collection discussed in FIG. 6 above.

Turning back to step 702, if unprocessed action definitions are not present, all of the action definitions for the Java class have been processed. At this point, a determination is made as to whether an unprocessed Java superclass is present for this Java class (step 712). A superclass is a parent class to a class. If an unprocessed Java superclass in present, this superclass is selected for processing (step 714). Pop-up menu items are added for this Java superclass (step 716) with the process then returning to step 712 as described above. Step 716 is a recursive call to the process in FIG. 7 for the Java superclass.

With reference again to step 712, if unprocessed Java superclasses are absent, a determination is made as to whether an unprocessed interface implemented by the Java class is present (step 718). An interface, as used with respect to the description of FIG. 7, defines a set of methods and constants to be implemented by another object. If an unprocessed interface implemented by the Java class is present, the unprocessed interface is selected for processing (step 720). Pop-up menu items for this interface are added by recursively calling the process in FIG. 7 (step 722) with the process then returning to step 718. Otherwise, the process terminates. In steps 716 and 722, the recursive call initiates the process in FIG. 7. The actions retrieved, however, are for the superclass or the interface rather than the original Java class when the process in FIG. 7 is first called.

With reference now to FIG. 8, a flowchart of a process used for executing an action is depicted in accordance with a preferred embodiment of the present invention. The process illustrated in FIG. 8 may be implemented in a menu process, such as menu process 304 in FIG. 3. The process in FIG. 8 is in response to a user selecting a pop-up menu item causing an actionperformed method to be called. This process results in an ActionEvent object being passed in the callback. Java provides an interface which can be implemented to handle callbacks on menu item selection, button presses, etc. This interface is called the ActionListener interface. The fully-qualified name is java.awt.event.ActionListener. The one method in this interface is the actionperformed method which receives an input parameter of type java.awt.event.ActionEvent. This ActionEvent object has the method getActionCommand, which returns a string for the menu item which is triggering the callback. In the present invention, when the actionperformed callback is invoked, the code interrogates the ActionEvent object (via the getActionCommand method) to determine which pop-up menu item has been selected. Then, the user's selected action can be instantiated and executed. The object contains the string name of the Java class saved in the process described in FIG. 6 above.

In FIG. 8, the process begins by retrieving the actioncommand for an action from the ActionEvent object passed in response to a selection of an action from menu item (step 800). The object, in this example, is a string version of the Java class as saved by the process described in FIG. 6 above. The action class is instantiated based on the actioncommand passing the object of the pop-up to the new action class (step 802). Then, the action class is executed (step 804) with the process terminating thereafter. This action class performs the process or logic to execute the action selected by the user. The mechanism of the present invention may be implemented in other programming environments, such as C++. In the C++ environment, the process of the present invention may be performed using C++ Runtime-type identification (RTTI) to determine the class type and then use that type to find the related actions. Generally, if a type for an object can be obtained, the related actions for the object can be looked up.

Thus, the present invention provides an improved method, apparatus, and computer implemented instructions for identifying actions that may be performed by or on an object. This identification is a dynamic identification in which the association of the actions with an object may be different and dynamically presented at runtime. The menu logic of the present invention can dynamically determine differing menu items at runtime based on registered class-to-action relationships, but the registration of the items related to Java classes is performed prior to runtime. This mechanism allows associating actions with objects without requiring a hard-coded relationship. In this manner, new actions may be associated or existing actions may be unassociated with an object as needed. The present invention provides for extensibility, which allows the behavior of a running program to be extended without redesigning, reworking or recompiling the program. Dynamic, runtime determination of a Java class to its related actions provides for extensibility. Hardcoded relationships between a Java class and its actions are undesirable because these types of relationships remove extensibility. The mechanism of the present invention reduces the need for using hardcoded relationships. Further, the mechanism provides a common interface for presenting actions to a user in which only the underlying associations between actions and objects change.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. Although the examples are discussed with respect to the Java programming language, the mechanism of the present invention may be implemented in other programming languages, such as, for example, C. Also, the associations in these examples are identified at runtime. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for dynamically associating actions with an object, comprising the computer implemented steps of:
responsive to selection of an object, determining an object type of the selected object;
determining actions which can be performed on the object type by other objects in a data processing system at the time of selection; and
associating the determined actions with the selected object.

2. The method claim 1, wherein the determining step further comprises:
querying the selected object for a runtime list of methods/actions known to object from a database;
retrieving a static list of methods/actions for the object type; and
combining the runtime list, static list, and actions by other objects to produce a combined list of actions for the object.

3. The method of claim 1, wherein the object is a Java object.

4. The method of claim 1, wherein the determining steps are performed on a Java class.

5. The method of claim 2, wherein object is graphical user interface object representative of a network resource and the combined list of actions is presented in the interface to a user.

6. The method of claim 2, wherein the method provides a static list of actions for a specific class.

7. A method in a data processing system for presenting actions associated with an object displayed in a graphical user interface, the method comprising:
dynamically associating actions with the object based on an object type of the object; and
responsive to a selection of the object, presenting the actions in the graphical user interface.

8. The method of claim 7, wherein the selection is made using a pointing device.

9. The method of claim 8, wherein the pointing device is one of a mouse, a track ball, a touch pad, a light pen, a touch screen, or a digitizing pad.

10. The method of claim 7, wherein the actions are presented as a pop-up menu.

11. The method of claim 7, wherein the actions are presented as at least one of a selectable list, a selectable table, a tree, a set of button, and check boxes.

12. The method of claim 7, wherein the actions are dynamically associated in response to the selection of the object.

13. The method of claim 7, wherein the actions are dynamically associated when the object is initialized.

14. The method of claim 7 further comprising:
adding a new action to the actions prior to dynamically associating the actions.

15. The method of claim 7, wherein changes to the actions result in only existing actions are presented.

16. The method of claim 7, wherein the method if implemented using a Java programming language.

17. A method in a data processing system for presenting actions associated with an object displayed in a graphical user interface, the method comprising:
associating actions with the object to form associated actions, wherein a hard-coded association between the associated actions and the object are absent, not extensible and undesirable; and
responsive to a selection of the object, presenting the actions in the graphical user interface.

18. The method of claim 17, wherein the object is a folder and wherein the program is a file navigation program.

19. The method of claim 17, wherein the object is a security object.

20. A data processing system comprising:
a bus system;
a communications unit connected to the bus system;
a memory connected to the bus system, wherein the memory includes a set of instructions; and
a processing unit connected to the bus system, wherein the processing unit executes the set of instructions to dynamically associate actions with the object; and present the actions in the graphical user interface in response to a selection of the object.

21. A data processing system comprising:
a bus system;
a communications unit connected to the bus system;
a memory connected to the bus system, wherein the memory includes a set of instructions; and
a processing unit connected to the bus system, wherein the processing unit executes the set of instructions to associate actions with the object to form associated actions, wherein a hard-coded association between the associated actions and the object are absent, not extensible and undesirable; and present the actions in the graphical user interface responsive to a selection of the object.

22. A data processing system comprising:
a bus system;
a communications unit connected to the bus system;
a memory connected to the bus system, wherein the memory includes a set of instructions; and
a processing unit connected to the bus system, wherein the processing unit executes the set of instructions to identify actions associated with the object to form associated actions in response to an execution of a program associated with the object; and present the actions in the graphical user interface in response to a selection of the object.

23. A data processing system for dynamically associating actions with an object, comprising:
first determining means, responsive to selection of an object, for determining an object type of the selected object;
second determining means for determining actions which can be performed on the object type by other objects in a data processing system at the time of selection; and
associating means for associating the determined actions with the selected object.

24. The data processing system as in 23 comprising:
querying means for querying the selected object for a runtime list of methods/actions known to object from a database;
retrieving means for retrieving a static list of methods/actions for the object type; and
combining means for combining the runtime list, static list, and actions by other objects to produce a combined list of actions for the object.

25. The data processing system of claim 23, wherein the object is a Java object.

26. The data processing system of claim 23, wherein the first determining means and the second determining means process a Java class.

27. The data processing system of claim 24, wherein object is graphical user interface object representative of a network resource and the combined list of actions is presented in the interface to a user.

28. The method of claim 24, wherein the method provides a static list of actions for a specific class.

29. A data processing system for presenting actions associated with an object displayed in a graphical user interface, the data processing system comprising:
dynamically associating means for dynamically associating actions with the object; and
presenting means, responsive to a selection of the object, for presenting the actions in the graphical user interface.

30. The data processing system of claim 29, wherein the selection is made using a pointing device.

31. The data processing system of claim 30, wherein the pointing device is one of a mouse, a track ball, a touch pad, a light pen, a touch screen, or a digitizing pad.

32. The data processing system of claim 29, wherein the actions are presented as a pop-up menu.

33. The data processing system of claim 29, wherein the actions are presented as at least one of a selectable list, a selectable table, a tree, a set of button, and check boxes.

34. The data processing system of claim 29, wherein the actions are dynamically associated in response to the selection of the object.

35. The data processing system of claim 29, wherein the actions are dynamically associated when the object is initialized.

36. The data processing system of claim 29, wherein the actions are dynamically associated at runtime.

37. The data processing system of claim 29 further comprising:
adding means for adding a new action to the actions prior to dynamically associating the actions.

38. The data processing system of claim 29, wherein changes to the actions result in only existing actions are presented.

39. The data processing system of claim 29, wherein the method if implemented using a Java programming language.

40. A data processing system for presenting actions associated with an object displayed in a graphical user interface, the data processing system comprising:
associating means for associating actions with the object to form associated actions, wherein a hard-coded association between the associated actions and the object are absent, not extensible and undesirable; and
presenting means, responsive to a selection of the object, for presenting the actions in the graphical user interface.

41. A data processing system for presenting actions associated with an object displayed in a graphical user interface, the data processing system comprising:
identifying means, responsive to an execution of a program associated with the object, for identifying actions associated with the object to form associated actions; and
presenting means, responsive to a selection of the object, for presenting the actions in the graphical user interface.

42. The data processing system of claim 41, wherein the object is a folder and wherein the program is a file navigation program.

43. The data processing system of claim 41, wherein the object is a security object.

44. A computer program product in a computer readable medium for dynamically associating actions with an object, the computer program product comprising:
first instructions, responsive to selection of an object, for determining an object type of the selected object;
second instructions for determining actions which can be performed on the object type by other objects in a data processing system at the time of selection; and
third instructions for associating the determined actions with the selected object.

45. A computer program product in a computer readable medium for presenting actions associated with an object displayed in a graphical user interface, the computer program product comprising:
first instructions for dynamically associating actions with the object; and
second instructions, responsive to a selection of the object, for presenting the actions in the graphical user interface.

46. A computer program product in a computer readable medium presenting actions associated with an object displayed in a graphical user interface, the computer program product comprising:
first instructions for associating actions with the object to form associated actions, wherein a hard-coded association between the associated actions and the object are absent, not extensible and undesirable; and
second instructions, responsive to a selection of the object, for presenting the actions in the graphical user interface.

47. A computer program product in a computer readable medium for presenting actions associated with an object displayed in a graphical user interface, the computer program product comprising:
first instructions, responsive to an execution of a program associated with the object, for identifying actions associated with the object to form associated actions; and
second instructions, responsive to a selection of the object, for presenting the actions in the graphical user interface.
